(19) United States
(12) Patent Application Publication
(10) Pub. No.: US 2010/0091084 A1
(43) Pub. Date: Apr. 15, 2010

(54) Combined video phone and television set

(76) Inventor: Keith Parker, Plainsboro, NJ (US)

Correspondence Address: Keith Parker, 81 Thoreau Drive, Plainsboro, NJ, 08536, US

(21) Appl. No.: 12/285,830

(22) Filed: Oct. 14, 2008

(51) Int. Cl. H04N 7/14

(52) U.S. Cl. 348/14.04; 348/E07.078

(57) ABSTRACT

This combined video phone and television set will revolutionize communications as we know them. It will bring together all peoples of the world for purposes of family, friendship, education, compassion, love and ecology. Its ease of use will allow any person to turn on the television set and dial up anyone in the world for the purposes above. It will contain a Caller ID unit in which privacy can be obtained and all of this can be performed in the comforts and conveniences of the every day household living room.

### DESCRIPTION

This invention was thought of and will be designed around the concept of bringing two existing technologies together. In our honest search of existing patents, we could not find one that included both of the technologies and therefore wish to have one created. The design may differ by the companies that have an interest in creating it, but it's basic foundation is as follows:
1. The Telephone—The telephone as we know it is a communication device which has been in existence since March 1876. This device has grown through the years and evolved to the degree that it can be used to communicate with people in the same household or those people(s) across the globe. The basic principals of the phone will not be changed. The telephone has grown to the degree that “1434395894829837312843763264578839490321818437485792487 8032840298313094830948758768942749302843947758457894308 5940852908234908549857847583432798490384902834908258478 4397239849023842093584495894322”¹ people in the world own them. As is the case with this invention, it will be incorporated into a new design as “Part One” of the invention. ¹http://wiki.answers.com/Q/How many people in the world own a telephone—Oct. 13, 2008.
2. The Television—The television as we know it is a communication device which has been in existence since Mar. 25, 1925. This device has grown through the years and has evolved, but not as steadily as one could expect. It was designed to bring the outside world into the homes, businesses, and now even cars and mobile phones of people. Specifications—The Television (Cont.)
3. It is estimated that “111,162,259” households exist in the United States and thought that each household has a television. Thereby estimating the bottom value of television ownership in the United States at “111,162,259” and growing steadily by the minute². Since this Patent would encompass the United States initially, the numbers are not being provided here for global television ownership. ²http://wiki.answers.com/Q/How many households are in the US—Oct. 13, 2008.
4. The combined Telephone and Television Set is the existence of our invention as brought forth in this documentation. Although the specifications for said invention would differ; dependant on the manufacturer and designer, the basic principal remains the same.

The process of bringing together the telephone and television set is one that could result in every household in America or globally, owning this device. If the numbers above represent households that wish to communicate by telephone or television, it is with our minds and hearts, we feel that each household in these geographic regions would naturally wish to explore ownership of a device in which they could not only speak to their families, friends, businesses, potential dates, job candidates, hospitals, hotels, and more (see detailed description), but that they could do so and also use this device to visually see the target person(s) as well.

We are not necessarily putting forth an exact design or manufacture of this invention, but rather the idea of its existence. Our plan is to market the device to existing manufactures and designers so that they may implement its features and put to good use the ideas set forth in this application and documentation. The basic idea and concept brought about by Keith Parker, the inventor of this appliance shall be used by the designer and/or manufacture for the purpose of hopeful global ownership of this device.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

To the best of my knowledge, I believe the field of endeavor for this invention's classification will be D14/130. The invention is definitely a part of the communication classification; we find it to be in the D14 Class. The section of 130 allows the combination of the television set and the telephone. Any references to other devices already in existence are purely generic in that we did not base or build this idea on knowledge of any existing devices. The invention sets forth the idea of combining the telephone and television set together as a means of taking those technologies and offering for convenience as well as an exciting new way of communicating not yet designed.

### BRIEF SUMMARY OF THE INVENTION

The invention of both the telephone and the television set profoundly changed the world. People could live anywhere in the world and communicate with the world outside and around them. The foundation of these ideas is what came to mind when creating a device in which households could “call” each other up on a telephone, and yet sit in the comfort of their living rooms or television rooms and see each other while having a chat. This idea expanded into how useful this invention could be in so many aspects of life. In the detailed description section, I have outlined what I believe to be the many facets of the invention for use by the general public and businesses. Although the television set has been improved time and time again with regard to style, clarity and ease of use, I have searched the depths of patents and web sites containing patents only to find an invention of this sort, is not yet in existence. In my thoughts, I imagine this device to also accommodate ecological needs in this global community as well. If people could watch their families grow in sickness and in health, if companies could interview candidates, if meeting all around the world could take place in such detail as if the parties were present, imagine the savings in fuel and therefore energies. The detailed uses I imagine being a part of this invention are endless. The Caller ID features of the invention allow users to block callers at any time for any reason. It is with this application and documentation; I feel this invention will change communication in the world as we know it. The telephone has evolved into mobile and even video usages; however the television has had somewhat of a standstill after including machinery to record and view. This invention will take the better of those two technologies and make them one. It's an exciting, innovative and “never been done” prospect that I offer with this invention.

### BRIEF DESCRIPTION OF THE SEVERAL VIEWS OF THE DRAWING

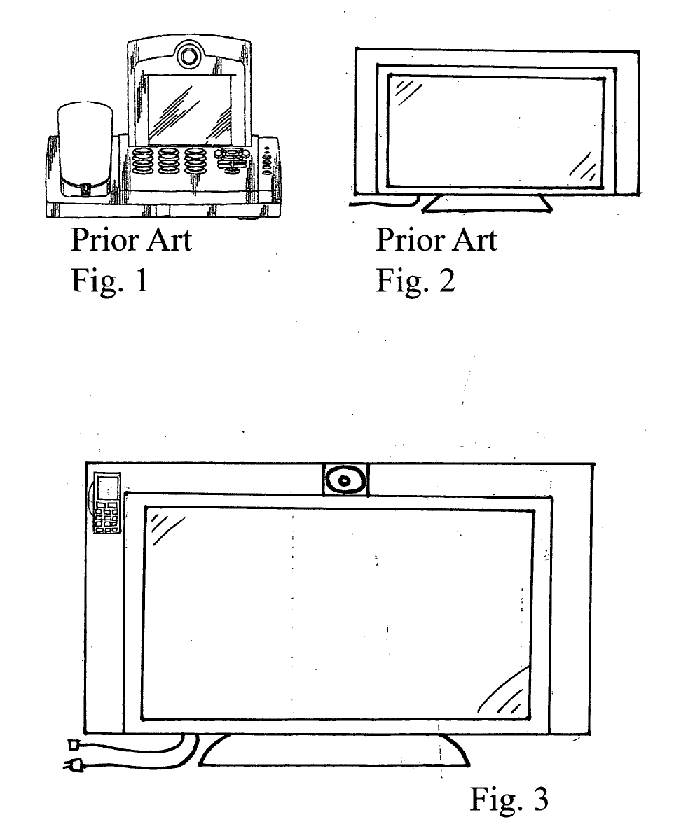

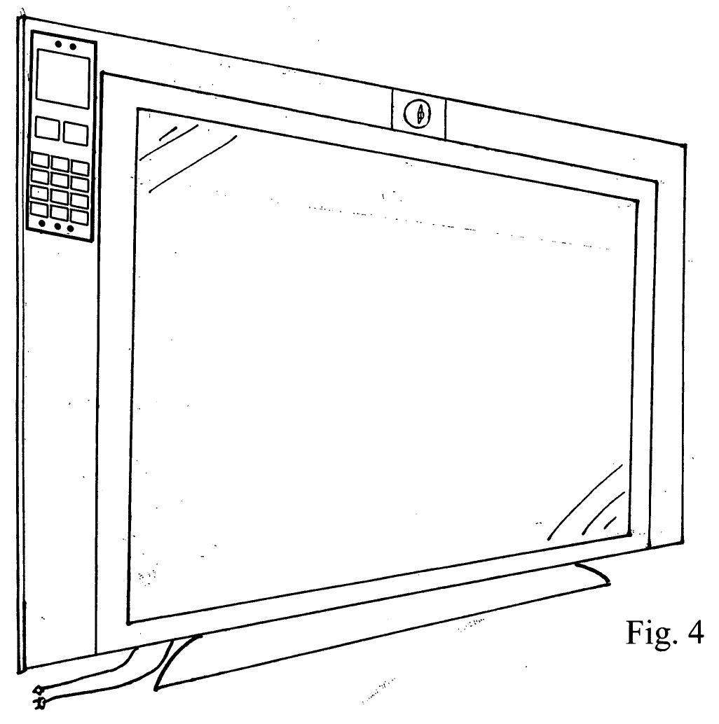

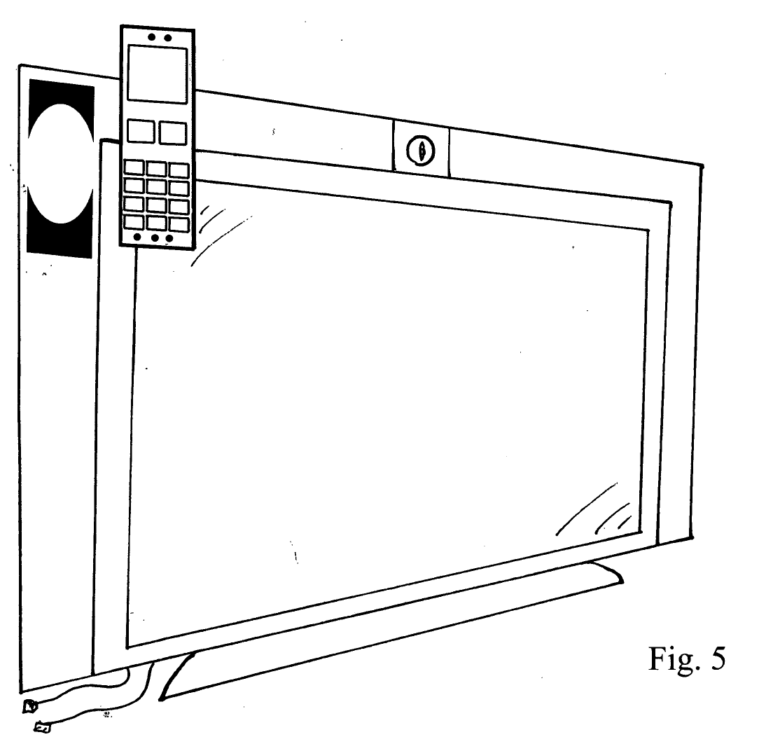

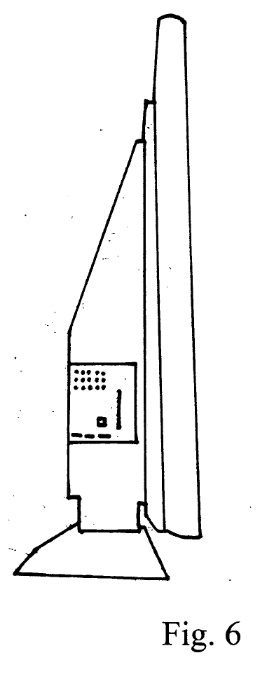

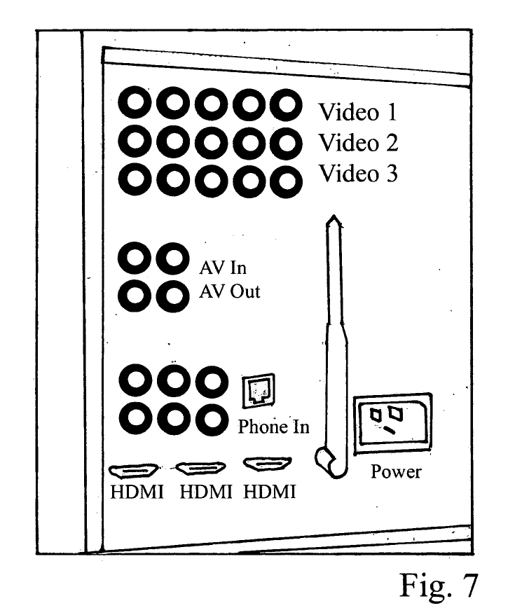

Because the idea of the invention is to bring together the combined efforts of two technologies, the design is one I feel should be created by the experts who already have these technologies in place. Inclusive in these specifications, are Replacement Sheet Drawings labeled FIG. 1 (represents Prior Art), FIG. 2 (represents Prior Art), FIG. 3, FIG. 4, FIG. 5, FIG. 6 and FIG. 7. To the best of my ability, these drawings/figures represent my vision of the Combined Video Phone And Television. After speaking with a member of the Inventor's Team at USPTO, I was encouraged to apply with a more generic drawing, since I am neither a designer nor a manufacturer. Please understand that this Combined Video Phone And Television can be made into any size screen. I have seen Video Phones which contain screen sizes so small that I hardly see the point. And the clarity of the picture is sub standard. With the Combined Video Phone And Television, the picture quality would be improved because the image(s) projected onto the screen would work with the inherent display of the television. This would allow a display of pixels that would auto adjust in accordance with whichever images were being presented. The television portion of the invention could be as small as a portable television or as large as a room. There is no limit to the size big or small, which would present a significant improvement over any of the technology currently being used for Video Phones today. This makes my invention more unique and more useful to those who feel as I do, that the tiny, unclear images are not what the public wants. Instead, they want a “visit” on this device which will mirror a “live” visit. I bring forth this idea of invention in order to market companies who would be interested in my ideas of how these two technologies combined will excite and enrich the public to the degree that every household globally will pursue the purchase of one. The drawing that is included in this application is simple in nature, yet so revolutionary for many phases of communication that nobody will want to be without one. And, each time a business or family member wishes to have one, the person(s) or people on the other end of the communication will need to have one in order for the communication to be complete. The Caller ID features will allow for privacy and convenience. The callers can be blocked at any time for any reason. Therefore, the application of said technology will inspire the need for greater communication in every day life as well as a new foundation for business to base their communications on.

### DETAILED DESCRIPTION OF THE INVENTION

The lists of uses for this device are endless. The initial thought processes for its creation were so that families could watch each other and grow with each other regardless of their geographic locations. Being a British Citizen who is also a resident of the United States of America via green card holder, I recognize the importance of staying close to your family when faced with being so far apart. Although mail services, faxes, telephones and airplanes are already on the list as a means to communicate, in each case the feeling of “being there” is left out. You see sporadic pictures of a baby growing up, or your elderly parents and in your heart, it shakes you, knowing that you cannot see each important spurt. The expense of airfare is something that most people cannot undertake, especially if they are working and also need the time off from their job. The consideration of energy waste should be on the top of everyone's list as a global neighbor. With a television set that is also a telephone, I imagine the “virtual visit” to be one that will assist in the cure of energy waste with the world today. It would allow people to visit with their families, friends to re-connect, hospital patients to interact with those who love them, and therefore help them on their way to speedy recovery. In addition, nursing home residents could connect with family, friends and children who might be at risk by bringing outside sickness and disease into an already fragile environment, as well as maternity wards and nurseries for the same reasons. I imagine parents who must travel for their jobs to be set up in a hotel where every room is equipped with a television which allows them to phone home and never miss out on all the every day moments their families have which actually result in the most special of moments once the kids are grown and gone. This is the next best and safest solution to online dating. Often time's people can be whomever they wish with a webcam. With an entire view of a person, it would be harder to be someone you are not. This could also result in entire families helping an innocent girl or boy make dating decisions. I imagine the Corporate world to simply explode with this new technology. The cost savings and energy efficiency is just mind boggling. Already in place are remote classrooms where individuals can sign up and take a class online. Currently though, one small screen of a webcam may not always be enough for the jittery student who feels a “live” teacher presents them with a greater success rate. Holidays and Birthdays would be changed forever as well. The blackout times the airlines experience during holidays could be a thing of the past. Perhaps a traveler who has spent money to travel only to be faced with sickness or harsh weather conditions, could now use this invention to take that trip from the comfort of their own home(s). Since elderly folks generally do not have the savvy it takes to operate intricate computers or cell phones, the invention presents them with a technology anyone can understand. The dial pad that exists on the television set and also offered as a handset will allow them to harness the technology they DO know and allow them to be a part of the newest, latest and greatest technology that exists on earth today! Although all families generally love each other and want to be together, it can be very trying to have people underfoot more than a day or two. With this invention, families can remain friendly and not get on each others nerves. You can visit as long as you like, get involved deeply in their lives and then just “click” them off at the end of it all, leaving you with that warm and fuzzy feeling you get from a warm family, yet be able to carry on your daily lives without them in the way. This device could be implemented in any size. Therefore you could fill the front of the room with a television/telephone that would allow instructors to teach dance, yoga, karate, pre-natal classes, cooking, and any lessons that would benefit mankind. It would make the lonely able to participate in activities they might not be willing to undertake in real life, or unable to participate in because they are unable to travel. Many elderly people or young mothers and fathers cannot drive and do not have access to public transportation. No more is the “world out there” a place they cannot get to. Everyone in every walk of life could participate. Classroom environments for school aged children would be changed forever. Instead of learning about the peoples of the world through books, pictures and video, they could join them live and really truly be a part of their lives. People are always more interested in other cultures and societies when those cultures become a part of them rather than a “dreamy” view that they shall never know up close. The world which is getting smaller, could also get friendlier once people understood each other better. As well as good, enriching, warm reasons, other reasons could include more harsh settings such as prisons. Imagine the poor mother or father who has children unable to visit their parent because they are in a prison environment that you do not wish to drag them to. Or in the case again, of an elderly person who simply cannot get out, or doesn't want to be a part of that element. They still could visit with the person in the institution and continue somewhat of a relationship without anyone being in harms way.

With a new, sleek, high tech look, every household globally will want to own one. The idea is so simple and yet so explosive with regard to it's benefits. The more I think about what the invention can mean to societies around the globe, the more I think it can help and make people feel good, educate them, enrich their lives and allow them to do things they never thought possible. Never again would a parent miss a birthday of a child or their parent, never again would a sick relative wither away with nobody around, never again would you miss any important moment that you wish you could be there for. Lastly, this idea could take security to a new level as well. Home monitoring, baby sitter monitoring, and pet monitoring could all be achieved. You could dial up the place you intend to be before leaving home and either watch from a television in another location or even on your cell phone. In either case, you are never far away from those that you love. In addition, you can use the Caller ID technologies included for privacy when needed. You can put blocks on in order to watch regular television or because you don't want to communicate at that time.

This invention will be a must have for every global neighbor we have. The environment will be better for it and I believe it to be the next wave of great technologies the world will know today. Any ordinary person of any ordinary skill level will be able to see the positives and necessity of this invention.

Lastly, since the main focal point of all households is the living room and/or the television set; why not use this to the best advantage and allow people to stay in the comfort of their own homes and still continue to accomplish any business at hand they desire.

### DRAWINGS (WHEN NECESSARY)

See Attached Drawing Titled “COMBINED VIDEO PHONE AND TELEVISION SET”

Replacement Sheets FIGS. 1 & 2 represents “Prior Art” from our original filing.

Replacement Sheets FIG. 3 represents the “Combined Video Phone and Television Set”

Replacement Sheets FIG. 4 represents a close up picture shot of the Combined Video Phone And Television Set. It includes a power lead, telephone jack and handset. The handset has the normal buttons of a telephone and also includes an LCD screen to show caller ID information when a video call is waiting.

Replacement Sheets FIG. 5 represents a close up picture of the Combined Video Phone And Television Set, demonstrating that the handset is removable in order to take a normal call or a video call. Replacement Sheets FIG. 6 represents a side view of the Combined Video And Television Set.

Replacement Sheets FIG. 7 represents a close up view of the Combined Video And Television Set's controls. The picture shows the phone jack plug in socket, the antenna for the phone, and the power supply which will power the television and the base unit for the telephone.

Drawings are pictured on the next five (5) pages and are also included in full drawings at the end of this specification.

1. The subject matter of this invention is simple. It claims that the telephone and television set combined together will change the world in an evolving technology that the world has not previously known. It will bring together people with regard to every facet of life as well as contribute to the importance energy and fuel conservation.
